(19) United States
(12) Patent Application Publication
(10) Pub. No.: US 2008/0110558 A1
(43) Pub. Date: May 15, 2008

(54) RFID TAG/LABEL REJECTION

(76) Inventors: James P. Harkins, Lake Forest, CA (US); Rick D. Blanton, Lake Forest, CA (US)

Correspondence Address: MACPHERSON KWOK CHEN & HEID LLP, 2033 GATEWAY PLACE, SUITE 400, SAN JOSE, CA, 95110, US

(21) Appl. No.: 11/559,815

(22) Filed: Nov. 14, 2006

(51) Int. Cl. B32B 38/10; B32B 41/00

(52) U.S. Cl. 156/249; 156/361; 156/247

(57) ABSTRACT

A label applicator system, upon detection of a bad label, moves a peel plate away from a platen roller and towards a take-up spool to increase the angle between the path of the liner toward the peel plate and the path of the liner away from the peel plate. The angle increases sufficiently to prevent the bad label from separating from the liner. The movement of the peel plate is approximately parallel to the movement of a tamp pad for moving and affixing a good label to a package. Because the processing of the bad label does not reduce tension in the liner to drop the liner into the path of the tamp pad and the movement of the peel plate does not cross into the tamp pad path, movement of the tamp pad is not hindered by the bad label processing.

### BACKGROUND

1. Field of Invention

The present invention relates to RFID tag/label printers and applicators and, in particular, to mechanisms to handle tags/labels in the printers and applicators.

2. Related Art

Typically, labels contain identifying information for packages and products. The labels are affixed to the packages so that the package or contents thereof can be identified or tracked without opening the package. Traditional labels have visually or optically readable information printed on them, such as alphanumeric text or barcodes. More recently, labels have used RFID (Radio Frequency Identification) tags embedded therein to store and convey information.

Regardless of the type of label, printers and applicators are used to apply the labels to packages. The labels are generally adhered to a web or liner, where the web is wound around a reel. As labels are unwound from the reel, they are written to, e.g., by a thermal print head, impact printer, or other suitable ink transferring method, or by an RFID encoder, with the desired information. The labels are then separated from the liner by a peel operation, thereby enabling the printed or dispensed label to be presented to an operator or applicator in a state ready to be directly applied to a product or package.

This peel operation generally consists of some sort of sharp-edged peel plate around which the label liner is wrapped under tension. As the label stock moves across this peel plate to the peel point, the liner is wrapped at a tight angle with respect to the direction of motion of the label, causing the leading edge of each label to separate from the liner at the peel point. The label itself (due to the stiffness of its material) continues to move in the same direction of travel, while the liner is wrapped and moves in a new direction, often 90 degrees or more from the direction of the label. This operation allows the label to be presented to an operator or applicator with the liner removed and the adhesive surface of the label uncovered and ready to apply to a package or product.

Once the label is peeled, it can be placed in front of a tamp pad to move the label to the package or product. In a typical system using a tamp pad, the tamp pad is located just past the peel plate or peel point. As the label is peeled off, the tamp pad is moved towards the package and contacts the non-adhesive side of the label. The tamp pad then continues to move toward the package, pushing the label along with it, until the label reaches the package or product. The tamp pad then presses the label onto the package, thereby affixing it to the package. After affixing the label, the tamp pad is returned to its starting position and awaits the next label.

Conventionally, each label is peeled from the liner regardless of the label quality. So, if a label is defective or bad, such as mis-printed information, unreadable tag or label, or improperly encoded tag, the bad label still is affixed to the package. This renders the package identification worthless or worse yet, in error. So, it is desirable to only peel off good labels and leave bad labels on the liner to be wound onto a discard take-up spool with the waste liner rather than given to an operator or applicator for application to a package or product. Since the bad labels remain on the liner and are wound on the take-up spool, the bad labels can also be analyzed later to determined what caused the defect.

Liners are generally wound onto a take up spool after the labels have been removed from them. This rewind system creates the tension in the liner—it is typically a servo driven motor that must compensate for liner roll diameter to keep constant tension. Other methods of controlling tension at the peel point have involved some sort of mechanism that actually relaxes the tension created by the tensioning system over the entire length of the liner.

This is effective in keeping the bad label on the liner, but this interferes with the tamp pad movement to reduce system throughput and efficiency. Specifically, when the tension in the liner is reduced, the liner path to the take-up spool ceases to be a straight line from the peel plate to the take-up spool. Instead, the path is curved due to the reduced tension. The curved portion can cross the line or area of the tamp pad movement. As a result, the tamp pad has to wait until the tension is re-applied to the liner and the liner path is away from the tamp pad path before the tamp pad can move again. In addition, if the tamp pad has just applied a good label, but the next label is detected as a bad label, the liner tension cannot be reduced until the tamp pad returns to its starting position and out of the path of the reduced tension liner. This slows down the throughput of the system, since the tamp pad cannot apply a good label until the liner is clear of its path.

Therefore, there is a need for a mechanism for a controlling the peel operation for a printer or applicator that overcomes the disadvantages of conventional mechanisms discussed above.

### SUMMARY

According to one aspect of the present invention, a peel plate moves away from a platen roller when a bad label is detected, thereby greatly increasing the angle from the edge of the peel plate to the liner path. This increased angle is such that the label is not peeled from the liner. As a result, the bad label remains affixed to the liner, where it is wound up with the liner in a take-up reel or spool. When a bad label is detected, the peel plate only moves away from the platen roller along the same or substantially same direction as the tamp pad. Consequently, the liner does not move into the path of the tamp pad and prevents interference or delay of the tamp pad movement when a bad label is detected.

In one embodiment, a label applicator system includes a liner platen roller and a take-up spool, with a tamp pad located near the platen roller and being movable between the platen roller and take-up spool. A peel plate is located near the platen roller and between the platen roller and tamp pad. The peel plate is movable along the direction of the tamp pad movement. A roll of labels is fed across a print head, such as an RFID encoder/reader, by the platen roller or other suitable mechanism. The peel plate is located past the platen roller. The labels are peeled off the liner as they move over the end of the peel plate, with tension being supplied by the take-up spool located at an angle of 90 degrees or greater from the path of the labels along the peel plate. When a bad label is detected, such as by the RFID encoder/reader or other label reader, the peel plate moves away from the platen roller and toward the take-up spool. This increases the angle at which the liner is pulled from the peel plate and prevents the bad label or tag from being peeled from the liner. Once the front of the bad label has sufficiently passed the peel plate, the peel plate is moved back to near the platen roller, allowing the bad label to remain on the liner and travel to the take-up reel.

The tamp pad is free to move during any movement of the peel plate since the liner and peel plate are never in the path of the tamp pad during the bad label processing. In addition, the bad label processing does not require a reduction in liner tension sufficient to drop the liner into the path of the tamp pad, as with conventional systems. As a result, the tamp pad can quickly apply a subsequent good label right after the peel pad movement ensures that the bad label will remain on the liner. Therefore, the tamp pad does not have to wait for the bad label processing to complete before processing a good label. This improves the efficiency and throughput of the label applicator system, as compared to conventional applicators in which the tension in the liner is reduced and the liner moves within the path of the tamp pad movement or cycle.

Embodiments of the present invention and their advantages are best understood by referring to the detailed description that follows.

### BRIEF DESCRIPTION OF THE DRAWING

FIG. 1 shows a portion of a conventional label applicator system;

FIG. 2 shows a portion of a label applicator system according to one embodiment of the present invention during a good label processing;

FIG. 3 shows a portion of the label applicator system of FIG. 2 during a bad label processing; and

FIG. 4 shows a flow chart for steps in controlling a peel operation of a label according to one embodiment.

It should be appreciated that like reference numerals are used to identify like elements illustrated in one or more of the figures.

### DETAILED DESCRIPTION

According to one aspect of the present invention, a peel plate in a label printer/applicator system is movable along the same direction as a tamp pad, where the peel plate moves toward a take-up spool when a bad label is detected to increase the angle that the bad label on a liner is pulled from the peel plate. As a result, the bad label remains affixed to the liner and is wound onto the take-up spool. Consequently, the bad label is not attached to the package, and the bad label can be later analyzed as to the reason it was classified as “bad”. The movement of the peel plate does not interfere with the movement of the tamp pad. This allows the tamp pad to move freely at any time during label processing and/or application, as neither the liner nor the peel plate interfere with the tamp pad movement.

FIG. 1 shows a portion of a conventional label printer or applicator system 100. System 100 includes a labels 102 adhered to a web or liner 104. Labels 102 can be any suitable label, such as a bar code label or other label containing visually/optically readable data or an RFID label with an embedded RFID tag to store desired data. A roller system includes a platen roller 106 or other suitable roller to move labels 102 across a print head (not shown) for reading and/or writing to each label. Labels 102 can be printed or encoded prior to reaching the print head so that the print head only reads the information printed on or stored in the labels. Alternatively, the print head, in addition to reading, can also write to or encode the labels. For optically readable labels, the print head may be a thermal print head or any other suitable ink delivering device. For RFID labels, the print head may be an RFID encoder/verifier.

System 100 also includes a peel plate 108 or other conventional peel mechanism located past platen roller 106. A take-up reel or spool 110 is located at an acute angle, e.g., 90 degrees or greater, from the path of labels 102. Take-up spool 110 provides tension or reduces tension in liner 104. A tamp pad 112 is located past peel plate 108 and above or away from platen roller 106 and peel plate 108. Tamp pad 112 is movable along arrow 114 to move a label to a package or product and affix the label thereto.

In normal operation, take-up spool 110 provides tension to liner 104, which keeps liner 104 in a straight line between the end of peel plate 108 and take-up spool 110 and clear of the path of tamp pad 112. However, when a bad label is detected, take-up spool 110 reduces tension in the liner, which allows the bad label to remain on the liner to be wound on take-up spool 110. The tension reduction also results in liner 104 dropping across the path of tamp pad 112. Consequently, either tamp pad 112 must wait until tension is re-applied to the liner to straighten out the liner or the system must wait until tamp pad 112 returns to its initial position before reducing tension in the liner. Either way, efficiency of label processing is reduced due to the wait time.

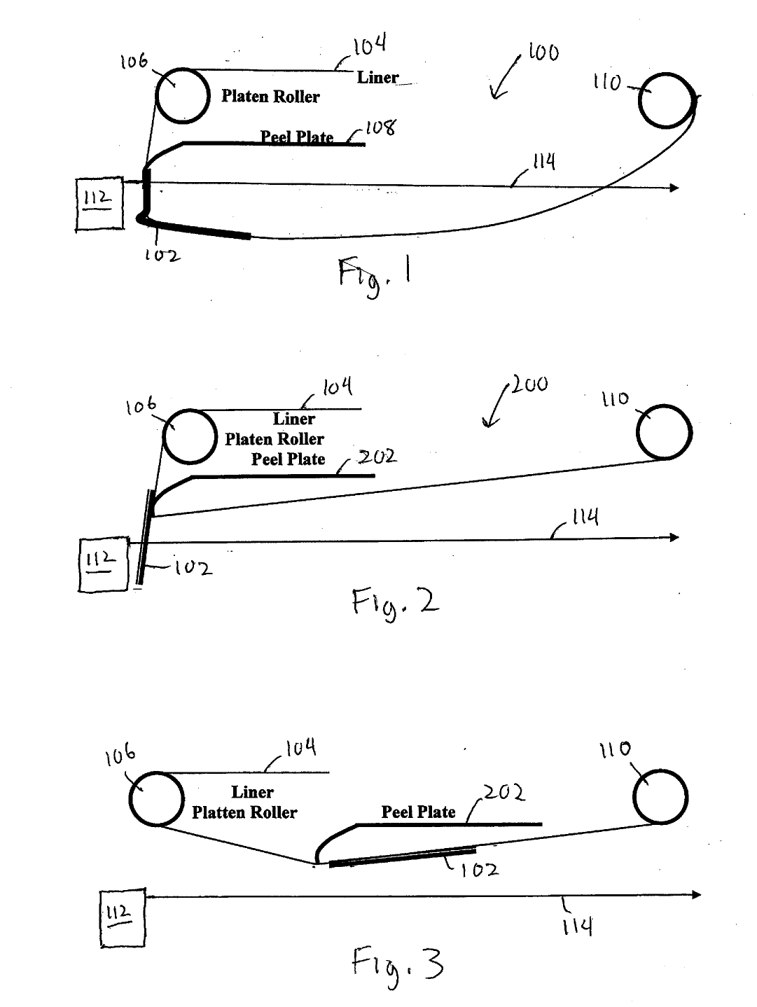

FIGS. 2 and 3 show a portion of a label printer and/or applicator system 200 according to one aspect of the present invention. FIG. 2 shows system 200 in normal operation, i.e., when a good label is peeled and applied to a package or product. FIG. 3 shows system 200 when a bad label is detected, where the bad label remains on the liner. System 200 includes a movable peel plate 202 positioned between tamp pad 112 and the roller system of platen roller 106 and take-up spool 110.

In FIG. 2, the labels on liner 104 are moved across a print head or reader (not shown) for determining whether a particular label is a good label or bad label. If the label is good, peel plate 202 remains in its normal position, i.e., adjacent platen roller 106, while label 102 is pulled across it. As label 102 passes the edge of peel plate 202, the label is peeled away from liner 104 due to the combination of the rigidity of the label and the sharp angle between the path of the liner approaching the peel plate and the path of the liner toward the take-up spool. Once label 102 moves in front of tamp pad 112, tamp pad 112 moves toward the label in the direction of arrow 114. With the adhesive side of label 102 facing away from tamp pad 112, tamp pad 112 contacts label 102 and moves the label, which is now completely removed from liner 104, toward a package, product, or other object (not shown) onto which the label will be affixed. After tamp pad 112 presses the adhesive side of label 102 onto the package, tamp pad 112 returns to its initial position for the next label.

In FIG. 3, system 200 has detected a bad label 102, such as by a print head or reader. In this case, the bad label should not be peeled off and should remain on liner 104 to be wound onto take-up spool 110. A bad label indication may occur in many different ways. For example, with a bar code label, a bad label is detected when the desired information is mis-printed or the printed information is unreadable. With an RFID label, a bad label is detected when desired information is not encoded properly into the RFID tag or when the tag is unreadable by the RFID reader. Depending on the tolerances for the labels, a bad label may even be indicated when the printed information (e.g., bar code) does not meet certain standards, even though the information is correct and can be read. Thus, in general, the system determines, based on its desired performance and criteria, whether a label is “bad” and thus should not be used, such as attachment to a package or product.

Peel plate 202 is located near platen roller 106, between platen roller 106 and tamp pad 112. Peel plate 202 can be located at any suitable distance from platen roller 106, depending on the system. However, peel plate 202 should be located close enough to tamp pad 112, such that the label is not peeled completely off before engaging with tamp pad 112. For example, the edge of peel plate 202 is not farther than the length of a label 102 away from tamp pad 112.

When a bad label is detected, peel plate 202 moves away from platen roller 106 and towards take-up spool 110. This increases the angle between the liner path towards the peel plate and the liner path moving away from the peel plate. The minimum distance the peel plate needs to travel in order for the bad label to remain affixed can depend on various factors, such as length of the label, the face stock thickness, the type of adhesive used, the liner rigidity, and distance from the peel plate to the line between the platen roller and take-up spool. As is readily seen, as the distance from the peel plate to the line between the platen roller and take-up spool increases, the more the peel plate has to move toward the center to create an angle shallow enough to prevent the label from separating from the liner. Further, as the peel plate moves toward the center, the angle increases, where the angle reaches a maximum at the center between the platen roller and the take-up spool.

The increased angle prevents label 102 from separating from liner 104 as the label passes the edge of peel plate 202. As a result, the bad label does not peel off the liner, but instead remains on the liner where it is rolled up into take-up spool 110. The bad label can then be analyzed later to determine why the label was detected as bad, such as a mis-print by the thermal head or a mis-read by the reader.

Such a system is advantageous for improving throughput and efficiency of the system. Because the liner and peel plate do not cross into the path of tamp pad 112 (as indicated by arrow 114), there is nothing to interfere with the tamp pad cycle. Consequently, the tamp pad can be quickly returned to its initial position and start the process for applying a good label, even when the bad label is still being processed, e.g., still moving into the take-up spool.

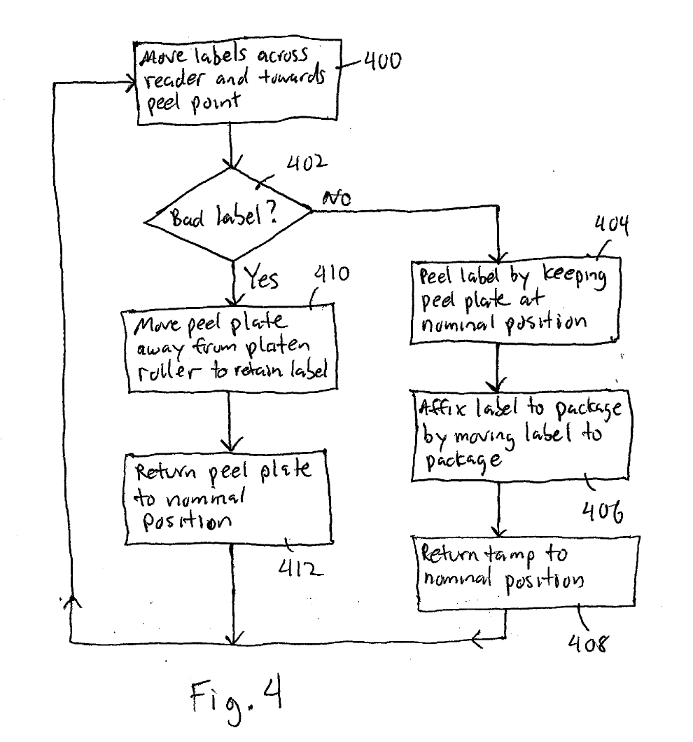

FIG. 4 is a flow chart illustrating a method of controlling a label peel operation according to one embodiment of the present invention. At operation 400, a roll of labels on a liner is moved across a label reader and toward a peel point, which is at the end of a peel plate in one example. The label reader can be a print head, RFID encoder, or any suitable mechanism for reading and/or writing to a label. A platen roller or other mechanism can be used to move the labels. At operation 402, a determination is made as to whether an individual label is bad, where “bad” can be based on any number of different criteria, such as whether data was written correctly, whether the label can be properly read, or whether the information on the label meets certain quality requirements. The determination can be made by reading or attempting to read information on the label, such as with a barcode or RFID reader.

If the label is good, i.e., not bad, then the label is peeled off the liner, at operation 404, by keeping the peel plate at its initial or nominal position. The combination of the tension applied to the liner and the angle from which the liner is pulled past the peel point and toward a take-up spool separates the label from the liner. At operation 406, the label is affixed to a package or product by moving a tamp pad to the label and carrying the label to the package. The tamp pad is then returned to its nominal position at operation 408 to await the next label. Note that this movement is continuous, but may be halted temporarily if desired.

If as determined at operation 402 that the label is bad, the peel pad is moved away from the platen roller and toward the take-up spool at operation 410. This increases the angle away from acute (i.e., 90 degrees or less) to towards obtuse (e.g., closer to 180 degrees). The increased angle prevents the label from separating from the liner as it is pulled across the peel plate and peel point. As a result, the bad label remains on the liner, where it is moved toward the take-up spool and wound up with the liner.

After the leading edge of the bad label has passed the peel point, the peel plate is moved back toward the platen roller at operation 412, such as with a pneumatic cylinder or other suitable mechanism for controlling peel plate movement. The next label is then moved toward the peel point. In this fashion, bad label processing does not interfere with the movement of the tamp pad, so that the tamp pad does not have to wait for the bad label processing to complete and/or the bad label processing does not have to wait until the tamp pad returns to its nominal position.

Such a system can be implemented using conventional circuitry. For example, once a bad tag or label is detected, which can be at any point prior to the label reaching the peel point but having sufficient time for the peel plate to be moved to a desired position, a signal is sent to a processor or circuitry controlling the operation of the drive rollers, peel plate movement, tamp pad, and/or the take-up spool. Once the “bad label signal” is received, a signal can be transmitted to the suitable element(s) for enabling a desired action. For example, the peel plate can be moved and/or the tamp pad cycle halted. The action can then be stopped, as determined by the associated processor, software, or circuitry. When the action is stopped can depend on various factors. These include, but are not limited to, the location of the label when the bad label is detected and the signal sent, the speed of the label, the length of the label, the amount of adhesion between the label and liner, the stiffness of the label or liner, the speed at which the peel plate is moved, and/or the distance between the peel plate and the line between the platen roller and take-up spool. As a result, the system can be automated so that whenever a bad label is detected by the system (or by user input), the bad label is automatically kept on the used liner portion to be discarded or analyzed.

Having thus described embodiments of the present invention, persons skilled in the art will recognize that changes may be made in form and detail without departing from the scope of the invention. Thus the invention is limited only by the following claims.

What is claimed is:

1. A system for controlling a label peeling operation on a roll of labels on a liner, comprising:
a roller;
a take-up spool onto which the liner is wound; and
a peel plate located at a nominal position adjacent the roller to enable a label to be separated the liner when the label is pulled across an end of the peel plate, wherein the peel plate is movable from the nominal position toward the take-up spool when a bad label is detected and movable back to the roller.

2. The system of claim 1, further comprising a tamp pad located directly adjacent to the peel plate, wherein the tamp pad is configured to move along a path approximately parallel to the peel plate movement.

3. The system of claim 2, wherein the peel plate is between the tamp pad and the roller and take-up spool.

4. The system of claim 2, wherein the peel plate is between the tamp pad and the roller and take-up spool at all times.

5. The system of claim 1, wherein the tamp pad is configured to engage with a label after the label has been separated from the liner.

6. The system of claim 5, wherein the tamp pad is configured to move and affix the label to a package.

7. The system of claim 1, wherein an angle between the liner path towards the peel plate and the liner path moving away from the peel plate increases to keep the bad label affixed to the liner as the bad label crosses the peel plate.

8. The system of claim 1, wherein the labels are RFID labels.

9. The system of claim 1, wherein the tamp pad is separated from the peel plate by a distance approximately the same as or less than a length of the label.

10. A system for controlling label peeling in a printer or applicator system comprising:
means for moving labels affixed to a liner toward a peel point;
means for determining whether a label affixed to the liner is bad;
means for providing tension to the liner at the peel point sufficient to peel the label from the liner; and
means for increasing an angle between the liner path towards the peel point and the liner path moving away from the peel point when a bad label is detected to prevent the bad label from separating from the liner.

11. The system of claim 10, wherein the means for increasing the angle comprises a moveable peel plate.

12. The system of claim 10, wherein the means for moving comprises a platen roller.

13. The system of claim 10, wherein the means for determining comprises a label reader.

14. The system of claim 13, wherein the label reader comprises an RFID reader.

15. The system of claim 15, wherein the means for reducing comprises a pair of clamps.

16. The system of claim 15, further comprising means for moving and affixing a label peeled from the liner to a package.

17. The system of claim 16, wherein the means for moving and affixing comprises a tamp pad.

18. The system of claim 16, wherein the means for increasing the angle and the means for moving and affixing move along approximately parallel paths.

19. A method for controlling a label peeling operation on a roll of labels affixed to a liner, comprising:
moving labels affixed to a liner toward a peel point;
determining whether a label affixed to the liner is bad;
providing tension to the liner at the peel point sufficient to peel the label from the liner; and
increasing an angle between the liner path towards the peel point and the liner path moving away from the peel point when a bad label is detected to prevent the bad label from separating from the liner.

20. The method of claim 19, further comprising moving a peeled label from the peel point to a package.

21. The method of claim 19, wherein the increasing comprises moving the peel point toward a take-up spool.

22. The method of claim 21, further comprising moving a peeled label from the peel point to a package, wherein moving the peeled label is along a path approximately parallel to movement of the peel point toward the take-up spool.
